(19) United States
(12) Patent Application Publication
(10) Pub. No.: US 2023/0060554 A1
(43) Pub. Date: Mar. 2, 2023

(54) COMMUNICATION DEVICE AND CONTROL METHOD

(71) Applicant: KABUSHIKI KAISHA TOKAI RIKA DENKI SEISAKUSHO, Aichi (JP)

(72) Inventors: Yuki KONO, Aichi (JP); Shigenori NITTA, Aichi (JP); Masateru FURUTA, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/794,475

(22) PCT Filed: Dec. 2, 2020
(86) PCT No.: PCT/JP2020/044784

§ 371 Date: Jul. 21, 2022

(30) Foreign Application Priority Data
Feb. 27, 2020 (JP) 2020-031519

(51) Int. Cl. H04W 64/00

(52) U.S. Cl. CPC H04W 64/00

(57) ABSTRACT

A communication device includes: a wireless communication section configured to perform wireless communication with another communication device; and a control section configured to control a location information acquisition process of acquiring location information indicating a location where the other communication device is present, on a basis of accuracy required for the location information, wherein the control section executes, as the location information acquisition process, a process including acquisition of the location information based on a result of wireless communication between the wireless communication section and the other communication device.

### TECHNICAL FIELD

The present invention relates to a communication device and a control method.

### BACKGROUND ART

In recent years, location information is used in various fields. For example, Patent Literature 1 listed below discloses a technology of warning a driver of a vehicle on a basis of location information of his/her own vehicle and location information of other vehicles.

### CITATION LIST

### Patent Literature

Patent Literature 1: JP 2016-143092A

### DISCLOSURE OF INVENTION

### Technical Problem

According to the technology described in the above-listed Patent Literature 1, the location information of the other vehicles with respect to the own vehicle is acquired with high accuracy by using the Global Positioning System (GPS) (global positioning satellite), vehicle roadside communication, and a ranging sensor together. However, Patent Literature 1 unthinkingly improves accuracy of the location information, and ignores inconveniences accompanying the improvement of accuracy of location information such as increases in processing load, delay, electric power consumption, and the like.

Accordingly, the present invention is made in view of the aforementioned issues, and an object of the present invention is to provide a mechanism that makes it possible to acquire location information with reasonable accuracy.

### Solution to Problem

To solve the above described problem, according to an aspect of the present invention, there is provided a communication device comprising: a wireless communication section configured to perform wireless communication with another communication device; and a control section configured to control a location information acquisition process of acquiring location information indicating a location where the other communication device is present, on a basis of accuracy required for the location information, wherein the control section executes, as the location information acquisition process, a process including acquisition of the location information based on a result of wireless communication between the wireless communication section and the other communication device.

To solve the above described problem, according to another aspect of the present invention, there is provided a communication device comprising: a wireless communication section configured to perform wireless communication with another communication device; and a control section configured to control a location information acquisition process on a basis of a signal received from the other communication device, the location information acquisition process being a process where the other communication device acquires location information on a basis of accuracy required for the location information indicating a location where the communication device is present, wherein, as the location information acquisition process, the control section controls a process including wireless communication between the wireless communication section and the other communication device.

To solve the above described problem, according to another aspect of the present invention, there is provided a control method comprising: performing wireless communication with another communication device; and controlling a location information acquisition process of acquiring location information indicating a location where the other communication device is present, on a basis of accuracy required for the location information, wherein the control over the location information acquisition process includes execution of a process including acquisition of the location information based on a result of wireless communication with the other communication device, as the location information acquisition process.

To solve the above described problem, according to another aspect of the present invention, there is provided a control method comprising: performing wireless communication with another communication device; and controlling a location information acquisition process on a basis of a signal received from the other communication device, the location information acquisition process being a process where the other communication device acquires location information on a basis of accuracy required for the location information indicating a location where the communication device is present, wherein the control over the location information acquisition process includes control over a process including wireless communication with the other communication device as the location information acquisition process.

### Advantageous Effects of Invention

As described above, according to the present invention, it is possible to provide the mechanism that makes it possible to acquire location information with reasonable accuracy.

### BRIEF DESCRIPTION OF DRAWINGS

FIG. 1 is a diagram illustrating an example of a configuration of a system according to an embodiment of the present invention.

FIG. 2 is a sequence diagram illustrating an example of a flow of a location information acquisition process executed in the system according to the embodiment.

FIG. 3 is a sequence diagram illustrating another example of the flow of the location information acquisition process executed in the system according to the embodiment.

FIG. 4 is a sequence diagram illustrating an example of a flow of a location information acquisition process executed in the system according to the embodiment.

FIG. 5 is a diagram for describing examples of settings of accuracy required for location information of a portable device according to the embodiment.

FIG. 6 is a diagram for describing examples of settings of accuracy required for location information of the portable device according to the embodiment.

FIG. 7 is a flowchart illustrating an example of a flow of a process executed by a communication unit according to the embodiment.

FIG. 8 is a flowchart illustrating an example of a flow of a process executed by the portable device according to the embodiment.

FIG. 9 is a flowchart illustrating an example of a flow of a process executed by the communication unit according to the embodiment.

### MODE(S) FOR CARRYING OUT THE INVENTION

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

<1. Configuration Example>

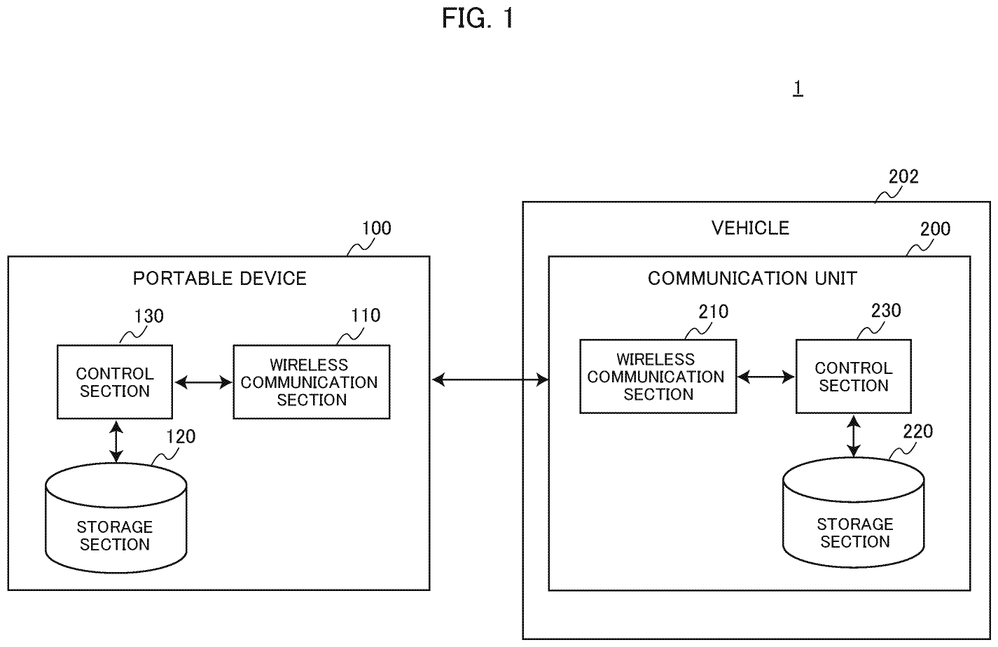

FIG. 1 is a diagram illustrating an example of a configuration of a system 1 according to an embodiment of the present invention. As illustrated in FIG. 1, the system 1 according to the present embodiment includes a portable device 100 and a communication unit 200. The communication unit 200 according to the present embodiment is installed in a vehicle 202. The vehicle 202 is an example of a target to be used by a user.

A communication device of an authenticatee (hereinafter, also referred to as a first communication device) and a communication device of an authenticator (hereinafter, also referred to as a second communication device) are involved in the present invention. In the example illustrated in FIG. 1, the portable device 100 is an example of the first communication device, and the communication unit 200 is an example of the second communication device.

When a user (for example, a driver of the vehicle 202) carrying the portable device 100 approaches the vehicle 202, the system 1 performs wireless communication for authentication between the portable device 100 and the communication unit 200 installed in the vehicle 202. Next, when the authentication succeeds, the vehicle 202 becomes available for the user by unlocking a door lock of the vehicle 202 or starting an engine of the vehicle 202. The system 1 is also referred to as a smart entry system. Next, respective structural elements will be described sequentially.

(1) Portable Device 100

The portable device 100 is configured as any device to be carried and used by the user. Examples of the any device include an electronic key, a smartphone, a wearable terminal, and the like. As illustrated in FIG. 1, the portable device 100 includes a wireless communication section 110, a storage section 120, and a control section 130.

Wireless Communication Section 110

The wireless communication section 110 has a function of performing wireless communication with the communication unit 200 installed in the vehicle 202. The wireless communication section 110 receives a wireless signal from the communication unit 200 installed in the vehicle 202. In addition, the wireless communication section 110 transmits a wireless signal to the communication unit 200 installed in the vehicle 202.

The wireless communication is performed between the wireless communication section 110 and the communication unit 200 in conformity with any wireless communication standard.

Examples of the wireless communication standard include a standard for transmitting and receiving ultra-wideband (UWB) signals. When impulse UWB is used in wireless communication of the UWB signals, it is possible to measure air propagation time of a radio wave with high accuracy by using the radio wave of ultra-short pulse width of a nanosecond or less, and it is possible to perform positioning and ranging with high accuracy on the basis of the propagation time. Note that, in many cases, the UWB refers to frequency bands of approximately 3 GHz to approximately 10 GHz.

Another example of the wireless communication standard includes Bluetooth Low Energy (BLE (registered trademark)). BLE is known as a wireless communication standard with low power consumption. In BLE, 2.4 GHz band signals are transmitted and received. Sometimes BLE is used for ranging based on reception strength of a signal. For example, a received signal strength indicator (RSSI) may be used as the reception strength.

Here, with regard to the wireless communication, it is known that a receiver consumes more electric power as a carrier wave has a higher frequency. This is because sampling frequency on the receiver side increases as the carrier wave has a higher frequency. Therefore, it can be said that, when using BLE, the receiver consumes less electric power than the wireless communication standard using UWB.

The wireless communication section 110 is configured as a communication interface that makes it possible to perform communication by using WUB or BLE.

Storage Section 120

The storage section 120 has a function of storing various kinds of information for operating the portable device 100. For example, the storage section 120 stores a program for operating the portable device 100, and an identifier (ID), password, and authentication algorithm for authentication, etc. For example, the storage section 120 is implemented by a storage medium such as flash memory and a processing device that performs recording/playback on/of the storage medium.

Control Section 130

The control section 130 has a function of executing processes in the portable device 100. For example, the control section 130 controls the wireless communication section 110 to perform communication with the communication unit 200 of the vehicle 202. In addition, the control section 130 reads information from the storage section 120 and writes information into the storage section 120. In addition, the control section 130 controls an authentication process between the portable device 100 and the communication unit 200 of the vehicle 202. The control section 130 also controls a location information acquisition process (to be described later). For example, the control section 130 includes a central processing unit (CPU) and an electronic circuit such as a microprocessor.

(2) Communication Unit 200

The communication unit 200 is prepared in association with the vehicle 202. Here, it is assumed that the communication unit 200 is installed in the vehicle 202 in such a manner that communication section 200 is installed in a vehicle interior of the vehicle 202, the communication unit 200 is built in the vehicle 202 as a communication module, or in other manners. As illustrated in FIG. 1, the communication unit 200 includes a wireless communication section 210, a storage section 220, and a control section 230.

Wireless Communication Section 210

The wireless communication section 210 has a function of performing wireless communication with the portable device 100. The wireless communication section 210 receives a wireless signal from the portable device 100. In addition, the wireless communication section 210 transmits a wireless signal to the portable device 100.

The wireless communication is performed between the wireless communication section 210 and the portable device 100 in conformity with any wireless communication standard. Examples of the wireless communication standard include BLE and a standard for transmitting and receiving ultra-wideband (UWB) signals. The wireless communication section 210 is configured as a communication interface that makes it possible to perform communication by using WUB or BLE.

Storage Section 220

The storage section 220 has a function of storing various kinds of information for operating the communication unit 200. For example, the storage section 220 stores a program for operating the communication unit 200, an authentication algorithm, and the like. For example, the storage section 220 is implemented by a storage medium such as flash memory and a processing device that performs recording/playback on/of the storage medium.

Control Section 230

The control section 230 has a function of controlling overall operation performed by the communication unit 200 and in-vehicle equipment installed in the vehicle 202. For example, the control section 230 controls the wireless communication section 210 to perform communication with the portable device 100. In addition, the control section 230 reads information from the storage section 220 and writes information into the storage section 220. The control section 230 also controls the authentication process between the portable device 100 and the communication unit 200 of the vehicle 202. The control section 230 also controls the location information acquisition process (to be described later). In addition, the control section 230 also functions as a door lock control section that controls the door lock of the vehicle 202, and opens/closes the door lock. The control section 230 also functions as an engine control section that controls the engine of the vehicle 202, and starts/stops the engine. Note that, a motor or the like may be installed as the power source in the vehicle 202 in addition to or instead of the engine. For example, the control section 230 is implemented by an electronic circuit such as an electronic control unit (ECU).

<2. Technical Features>

(1) Location Information Acquisition Process

The communication unit 200 (or control section 230 to be precise) controls the location information acquisition process. The location information acquisition process is a process of acquiring location information indicating a location where the portable device 100 is present. The portable device 100 (or control section 130 to be precise) controls the location information acquisition process on the basis of a signal received from the communication unit 200. In other words, the portable device 100 and the communication unit 200 cooperate with each other and perform the process where the communication unit 200 acquires the location information indicating the location where the portable device 100 is present. The location information acquisition process makes it possible for the communication unit 200 to acquire the location information indicating the location where the portable device 100 is present.

Hereinafter, the location information indicating the location where the portable device 100 is present is also referred to as the location information of the portable device 100. The location information of the portable device 100 according to the present embodiment is relative location information of the portable device 100 with respect to the communication unit 200. Specifically, the location information of the portable device 100 is information indicating a distance between the communication unit 200 (or the wireless communication section 210 to be precise) and the portable device 100 (or the wireless communication section 110 to be precise).

The location information acquisition process includes wireless communication between the wireless communication section 110 and the wireless communication section 210. In addition, the location information acquisition process also includes a process where the control section 230 acquires the location information of the portable device 100 on the basis of a result of the wireless communication. A location information acquisition process based on propagation time of signals and a location information acquisition process based on reception strength of a signal may be performed as the location information income process. Next, the respective location information acquisition processes will be described in detail.

Location Information Acquisition Process Based on Propagation Time of Signal

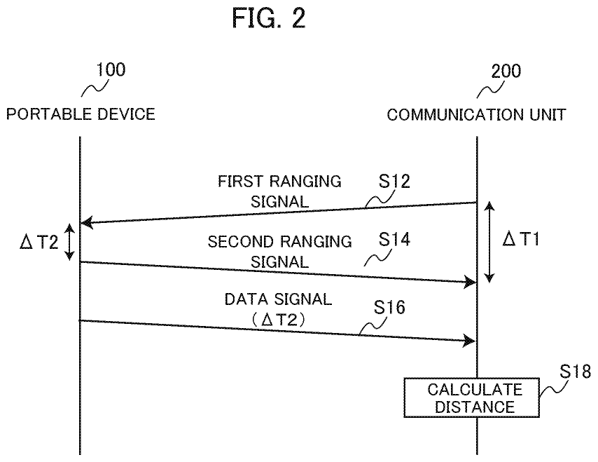

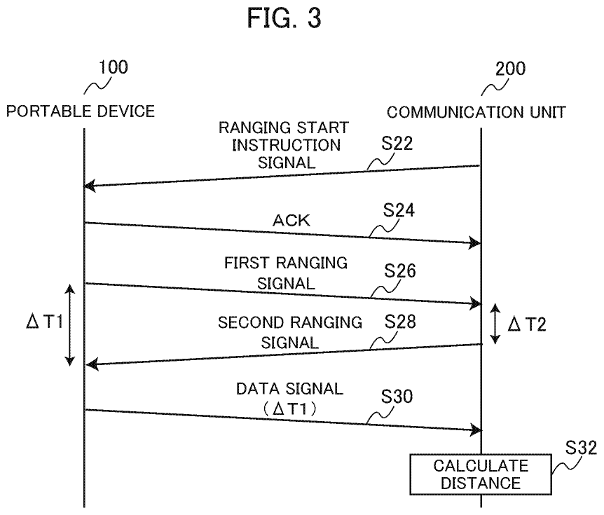

When acquiring the location information on the basis of a result of the wireless communication in the location information acquisition process, the location information of the portable device 100 may be acquired on the basis of propagation time of signals. The propagation time is time from transmission to reception of the signal between the portable device 100 and the communication unit 200. Such a process is also referred to as the location information acquisition process based on propagation time of signals. Next, examples of a flow of the location information acquisition process based on propagation time of signals will be described with reference to FIG. 2 and FIG. 3.

FIG. 2 is a sequence diagram illustrating an example of a flow of a location information acquisition process executed in the system 1 according to the present embodiment. The portable device 100 and the communication unit 200 are involved in this sequence. Note that, ranging signals and a data signal are transmitted and received in this sequence. The ranging signals are signals transmitted and received for ranging. To the ranging signals, indices such as “first” and “second” are assigned in order of transmission. The ranging signals may be configured in a frame format that does not include a payload part for storing data or in a frame format that includes the payload part. The data signal is a signal that carries data. The data signal is preferably configured in the frame format that includes the payload part for storing data.

As illustrated in FIG. 2, the wireless communication section 210 of the communication unit 200 first transmits a first ranging signal (Step S12). Next, when the first ranging signal is received from the communication unit 200, the wireless communication section 110 of the portable device 100 transmits a second ranging signal in response to the first ranging signal (Step S14). At this time, the control section 130 of the portable device 100 measures a time period ΔT2 that is a time period from when the portable device 100 receives the first ranging signal to when the portable device 100 transmits the second ranging signal. On the other hand, when the second ranging signal is received from the portable device 100, the control section 230 of the communication unit 200 measures a time period ΔT1 that is a time period from when the communication unit 200 transmits the first ranging signal to when the communication unit 200 receives the second ranging signal. Next, the wireless communication section 110 of the portable device 100 transmits the data signal including information indicating the time period ΔT2 (Step S16). Next, when the data signal is received, the control section 230 of the communication unit 200 calculates the distance between the portable device 100 and the communication unit 200 on the basis of the measured time period ΔT1 and the time period ΔT2 indicated by the information included in the data signal (Step S18). Specifically, propagation time of a one-way signal is calculated by subtracting ΔT2 from ΔT1 and dividing the subtracted value by 2, and then the distance between the portable device 100 and the communication unit 200 is calculated by multiplying the propagation time by speed of the signal.

FIG. 3 is a sequence diagram illustrating another example of the flow of the location information acquisition process executed in the system according to the present embodiment. The portable device 100 and the communication unit 200 are involved in this sequence. Note that, in this sequence, a ranging start instruction signal and an acknowledgment (ACK) signal are transmitted and received in addition to the ranging signals and the data signals. The ranging start instruction signal is a signal for instructing to transmit the ranging signals. The ACK signal is a signal for issuing notification indicating successful reception from the receiver to the transmitter.

As illustrated in FIG. 3, the wireless communication section 210 of the communication unit 200 first transmits the ranging start instruction signal (Step S22). Next, when the ranging start instruction signal is received, the wireless communication section 110 of the portable device 100 transmits the ACK signal in response to the ranging start instruction signal (Step S24). Next, the wireless communication section 110 of the portable device 100 transmits the first ranging signal (Step S26). Next, when the first ranging signal is received from the portable device 100, the wireless communication section 210 of the communication unit 200 transmits the second ranging signal in response to the first ranging signal (Step S28).

At this time, the control section 230 of the communication unit 200 measures a time period ΔT2 that is a time period from when the communication unit 200 receives the first ranging signal to when the communication unit 200 transmits the second ranging signal. On the other hand, when the second ranging signal is received from the communication unit 200, the control section 230 of the portable device 100 measures a time period ΔT1 that is a time period from when the portable device 100 transmits the first ranging signal to when the portable device 100 receives the second ranging signal. Next, the wireless communication section 110 of the portable device 100 transmits the data signal including information indicating the time period ΔT1 (Step S30). Next, when the data signal is received, the control section 230 of the communication unit 200 calculates the distance between the portable device 100 and the communication unit 200 on the basis of the measured time period ΔT2 and the time period ΔT1 indicated by the information included in the data signal (Step S32).

Note that, the ranging signals are desirably transmitted as UWB signals in the location information acquisition process based on propagation time of signals. This is because, when impulse UWB is used in wireless communication of the UWB signals, it is possible to perform ranging with high accuracy on the basis of the propagation time as described above.

Location Information Acquisition Process Based on Reception Strength of Signal

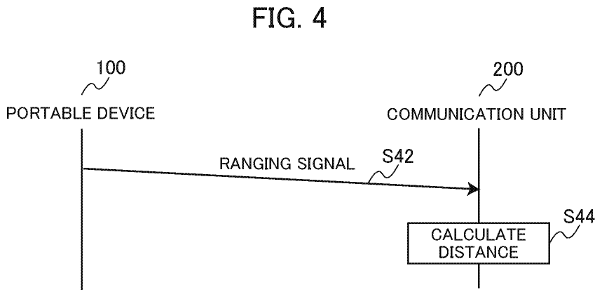

When acquiring the location information on the basis of a result of the wireless communication in the location information acquisition process, the location information of the portable device 100 may be acquired on the basis of reception strength of a signal. Such a process is also referred to as the location information acquisition process based on reception strength of a signal. Next, an example of a flow of the location information acquisition process based on reception strength of a signal will be described with reference to FIG. 4.

FIG. 4 is a sequence diagram illustrating an example of a flow of a location information acquisition process executed in the system 1 according to the present embodiment. The portable device 100 and the communication unit 200 are involved in this sequence. As illustrated in FIG. 4, the wireless communication section 110 of the portable device 100 first transmits a ranging signal (Step S42). Next, when the ranging signal is received from the communication unit 200, the control section 230 of the communication unit 200 measures reception strength of the ranging signal and calculates a distance between the portable device 100 and the communication unit 200 on the basis of the measured reception strength (Step S44).

Note that, the ranging signal is desirably transmitted as a BLE signal in the location information acquisition process based on reception strength of a signal. This is because, when using BLE, the receiver consumes less electric power than the wireless communication standard using UWB as described above.

(2) Control Over Location Information Acquisition Process

The communication unit 200 (or control section 230 to be precise) controls the location information acquisition process on the basis of accuracy required for the location information of the portable device 100. Specifically, the communication unit 200 controls the location information acquisition process in such a manner that the location information is acquired with high accuracy in the case where high accuracy is required for the location information of the portable device 100. On the other hand, the communication unit 200 controls the location information acquisition process in such a manner that the location information is acquired with low accuracy in the case where low accuracy is required for the location information of the portable device 100. This makes it possible to acquire the location information with reasonable accuracy.

Accuracy Required for Location Information of Portable Device 100

The accuracy required for the location information of the portable device 100 is set for each location. In addition, the communication unit 200 controls the location information acquisition process on the basis of accuracy required for location information of the portable device 100, the location information being set for a location where the portable device 100 had been present, the location being indicated by location information acquired in past. The communication unit 200 performs the location information acquisition process repeatedly. In addition, a next location information acquisition process is controlled on the basis of accuracy set for a location of the portable device 100, the location being indicated by location information of the portable device 100 acquired in the most recently performed location information acquisition process, for example. This makes it possible to acquire the location information with accuracy level corresponding to a latest location of the portable device 100.

Note that, the location information of the portable device 100 acquired in the past is not limited to the location information of the portable device 100 acquired in the most recently performed location information acquisition process. For another example, the location information of the portable device 100 acquired in the past may be location information obtained by averaging pieces of location information of the portable device 100 acquired in a plurality of most recent location information acquisition processes.

Typically, the communication unit 200 sets the accuracy required for the location information of the portable device 100. Needless to say, it is also possible for the portable device 100 to set the accuracy required for the location information of the portable device 100.

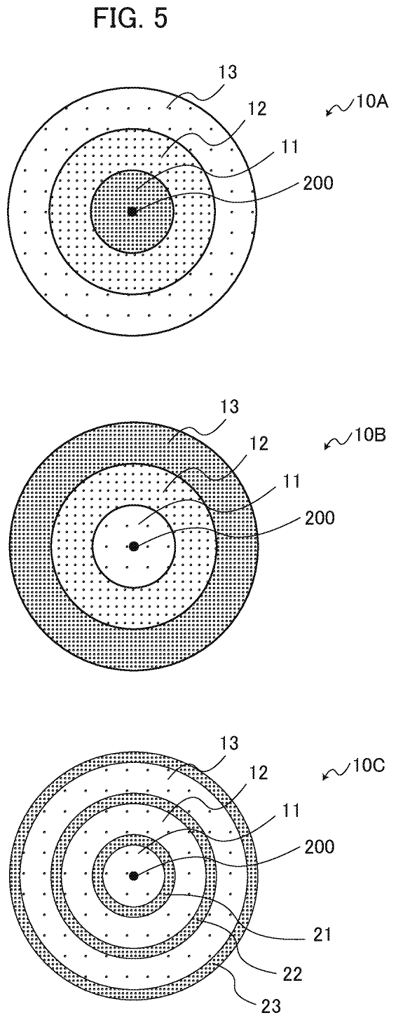

Next, examples of settings of the accuracy required for location information of the portable device 100 will be described with reference to FIG. 5.

FIG. 5 is a diagram for describing the examples of settings of the accuracy required for location information of the portable device 100 according to the present embodiment. With regard to settings 10A to 10C illustrated in FIG. 5, a region 11 is a region where a distance to the communication unit 200 is a short distance. A region 12 is a region where a distance to the communication unit 200 is a middle distance. A region 13 is a region where a distance to the communication unit 200 is a long distance. With regard to hatch patterns of the respective regions, a coarser hatch pattern means that higher accuracy is required for location information of the portable device 100, and a finer hatch pattern means that lower accuracy is required for the location information of the portable device 100. In addition, a region with no hatch pattern means that the lowest accuracy is required for the location information of the portable device 100. When the setting 1A is employed, higher accuracy is required for the location information of the portable device 100 as the distance to the communication unit 200 gets shorter. When the setting 10B is employed, higher accuracy is required for the location information of the portable device 100 as the distance to the communication unit 200 gets longer. When the setting 10C is employed, low accuracy is equally required for the location information of the portable device 100 in regions 11, 12, and 13, and high accuracy is equally required for the location information of the portable device 100 in boundary parts 21, 22, and 23 of the regions 11, 12, and 13.

The location information of the portable device 100 is used for providing a service corresponding to the location where the portable device 100 is present. In addition, the accuracy required for the location information of the portable device 100 may be set for each service. In other words, the communication unit 200 may control the location information acquisition process on the basis of accuracy required for the location information of the portable device 100 depending on services to be provided. This makes it possible to acquire the location information with reasonable accuracy depending on each service.

Examples of such services include a service related to remote operation of the vehicle 202. Examples of the service related to remote operation include a service of opening a door lock of the vehicle 202. Such a service makes it possible to open the door lock of the vehicle 202 in the case where the portable device 100 enters a region within a predetermined distance to the vehicle 202. Here, the door lock is desirably opened on the basis of highly accurate location information. Therefore, for example, the setting 10A illustrated in FIG. 5 is employed for the service of opening the door lock of the vehicle 202. Examples of the service for which a similar setting may be employed include a service of starting the engine of the vehicle 202.

Here, the setting is desirably configured in such a manner that high accuracy is required for location information of the portable device 100 in a region including a region within a distance at which a service is executed. For example, in the case of opening the door lock if the portable device 100 enters a region within 2 meters from the communication unit 200, the region 11 based on the setting 10A is desirably set as a region located within 3 meters from the communication unit 200, for example. The region includes a region located at a distance of 2 meters from the communication unit 200. This makes it possible to acquire highly accurate location information before the portable device 100 reaches a distance at which the service of opening the door lock is executed. Therefore, it is possible to open the door lock at an appropriate timing.

For similar reason, in the case where the setting 10C illustrated in FIG. 5 is employed for the service of opening the door lock of the vehicle 202, the setting is desirably configured in such a manner that the boundary part 21 between the region 11 and the region 12 includes a region located at a distance of 2 meters from the communication unit 200. In this case, it is possible to intensively acquire highly accurate location information immediately before and after the portable device 100 reaches a distance at which a service is executed.

Another example of the service related to remote operation includes a service of closing the door lock of the vehicle 202. Such a service makes it possible to close the door lock of the vehicle 202 in the case where the portable device 100 gets away from the vehicle 202 by a predetermined distance or more. Here, the door lock is desirably closed on the basis of highly accurate location information. Therefore, for example, the setting 10B illustrated in FIG. 5 is employed for the service of closing the door lock of the vehicle 202. Also in this example, the setting is desirably configured in such a manner that high accuracy is required for location information of the portable device 100 in a region including a region within a distance at which the service is executed. For example, in the case of closing the door lock if the portable device 100 gets away from the communication unit 200 by 10 meters or more, the region 13 based on the setting 10B is desirably set as a region located at a distance of 8 to 12 meters from the communication unit 200, for example. The region includes a region located at a distance of 10 meters from the communication unit 200. This makes it possible to acquire highly accurate location information before the portable device 100 reaches a distance at which the service of closing the door lock is executed. Therefore, it is possible to close the door lock at an appropriate timing.

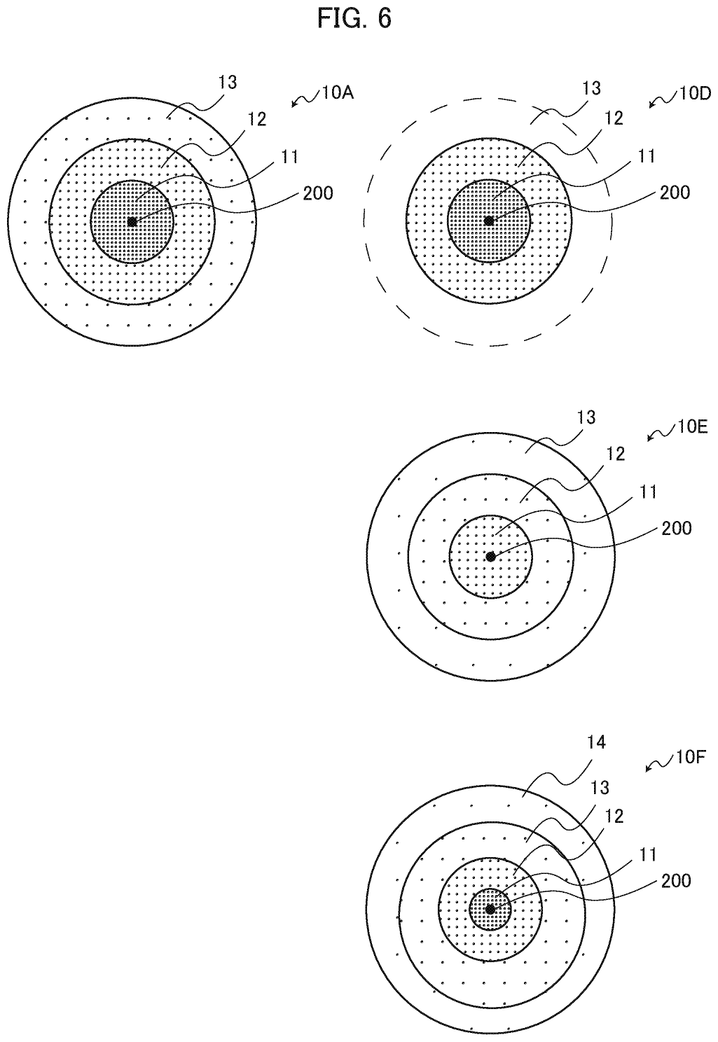

The accuracy required for the location information of the portable device 100 may be set on the basis of amount of battery charge remaining in at least any of the portable device 100 and the communication unit 200. For example, the setting is configured in such a manner that higher accuracy is required for the location information of the portable device 100 when the amount of remaining battery charge is larger. Alternatively, the setting is configured in such a manner that lower accuracy is required for the location information of the portable device 100 when the amount of remaining battery charge is smaller. As described later, much electric power is consumed to acquire the highly accurate location information. In this respect, it is possible to allow the battery to last a long time by configuring the setting on the basis of the amount of remaining battery charge. Next, examples of setting the accuracy required for location information of the portable device 100 on the basis of the amount of remaining battery charge will be described with reference to FIG. 6.

FIG. 6 is a diagram for describing the examples of settings of the accuracy required for location information of the portable device 100 according to the present embodiment. FIG. 6 illustrates settings 10D to 10F. that may be employed in the case where the setting 10A illustrated in FIG. 5 is employed and the amount of remaining battery charge decreases. When the setting 10D is employed, accuracy lower than the setting 10A is required for the location information of the portable device 100 in the region 13. When the setting 10E is employed, accuracies lower than the setting 10A are required for the location information of the portable device 100 in the respective regions 11 to 13. When the setting 10F is employed, regions 11 to 13 are smaller than the respective regions based on the setting 10A, and a region 14 is provided outside the region 13. In the region 14, accuracy lower than the region 13 is required. When any of the settings 10D to 10F. is employed, accuracy lower than the setting 10A is required for the location information of the portable device 100. This allows the battery to last longer by switching from the setting 10A to any of the settings 10D to 10F.

Control Over Transmission Interval of Location Information Acquisition Signal

The wireless communication performed in the location information acquisition process includes repetitive transmission of a location information acquisition signal. The location information acquisition signal is a signal for causing the communication unit 200 to acquire the location information of the portable device 100. For example, the location information acquisition signal according to the present embodiment is the first ranging signal according to the example illustrated in FIG. 2 and the ranging start instruction signal illustrated in FIG. 3. As described above, the communication unit 200 performs the location information acquisition process repeatedly. Therefore, the communication unit 200 transmits the location information acquisition signals each time the location information acquisition process is performed.

In addition, the communication unit 200 controls a transmission interval set for the repetitive transmission of the location information acquisitions signals. In other words, the communication unit 200 controls the interval of executing the location information acquisition process. Specifically, the communication unit 200 controls the transmission interval set for the repetitive transmission of the location information acquisitions signals, on the basis of the accuracy required for the location information of the portable device 100. For example, the communication unit 200 lengthens the transmission interval as the accuracy required for the location information of the portable device 100 deteriorates. This can reduce electric power consumption. Alternatively, the communication unit 200 shortens the transmission interval as the accuracy required for the location information of the portable device 100 improves. This makes it possible to acquire the location information of the portable device 100 with high accuracy in terms of time (in other words, with less delay).

On the other hand, the wireless communication performed in the location information acquisition process performed by the portable device 100 includes repetitive reception of the location information acquisition signal. In other words, the wireless communication performed in the location information acquisition process performed by the portable device 100 includes repetitive standby for reception of the location information acquisition signal. In addition, the portable device 100 controls a reception standby interval set for the repetitive reception of the location information acquisitions signal.

Here, the reception standby interval is a time interval from an end of the reception standby to a start of next reception standby. Specifically, the portable device 100 lengthens the reception standby interval as the accuracy required for the location information of the portable device 100 deteriorates. This can reduce electric power consumption.
Alternatively, the portable device 100 shortens the reception standby interval as the accuracy required for the location information of the portable device 100 improves. This allows the communication unit 200 to acquire the location information of the portable device 100 with high accuracy in terms of time (in other words, with less delay).

Note that, the reception standby means a state capable of acquiring and processing desired signals. The state capable of acquiring and processing desired signals may mean to operate an analog-to-digital converter or the like to import a signal received via an antenna into the processing device. In addition, the state capable of acquiring and processing a desired signal may mean to start performing various kinds of subsequent processes on a signal imported into the processing device. Note that, the state capable of acquiring and processing a signal may mean to receive the desired signal via the antenna, in the case where the portable device 100 is configured in such a manner that the processing device imports a signal when reception of a desired signal via an antenna is detected.

Note that, it is also possible for the portable device 100 to receive information indicating desired accuracy from the communication unit 200 and control the reception standby interval on the basis of the received information. Alternatively, the communication unit 200 may instruct the portable device 100 about the reception standby interval to be set, and the portable device 100 may control the reception standby interval in accordance with the instruction from the communication unit 200.

Control Over Wireless Communication Standard and Location Information Calculation Algorithm

The wireless communication performed in the location information acquisition process may use any of a plurality of wireless communication standards. In this case, the communication unit 200 selects a wireless communication standard to be used in the location information acquisition process. Specifically, the communication unit 200 selects a wireless communication standard to be used in the location information acquisition process, on the basis of the accuracy required for the location information of the portable device 100.

In addition, the communication unit 200 may select a location information calculation algorithm to be used in the location information acquisition process. Specifically, the communication unit 200 may select which of the location information acquisition process based on propagation time of signals and the location information acquisition process based on reception strength of a signal to perform. The communication unit 200 makes the selection on the basis of the accuracy required for the location information of the portable device 100.

For example, the communication unit 200 selects a wireless communication standard and a location information calculation algorithm that make it possible to perform highly accurate ranging, in the case where accuracy higher than a predetermined threshold is required for the location information of the portable device 100. Specifically, the communication unit 200 uses the UWB to perform wireless communication in the location information acquisition process, and selects the location information acquisition process based on propagation time of signals. As described above, when impulse UWB is used in the wireless communication of the UWB signals, it is possible to perform ranging with high accuracy on the basis of the propagation time. Therefore, by making the selection as described above, it is possible to acquire highly accurate location information of the portable device 100.

For example, the communication unit 200 selects a wireless communication standard and a location information calculation algorithm that make it possible to reduce electric power consumption, in the case where accuracy lower than a predetermined threshold is required for the location information of the portable device 100. Specifically, the communication unit 200 uses BLE to perform wireless communication in a location information acquisition process, and selects the location information acquisition process based on reception strength of a signal. As described above, when using BLE, the receiver consumes less electric power than the wireless communication standard using UWB. In addition, the location information acquisition process based on reception strength of a signal does not require measurement of time, reporting of a result of the measurement, calculation of propagation time, or the like, which are performed in the location information acquisition process based on propagation time of signals illustrated in FIG. 2 and FIG. 3. Therefore, it is possible to reduce processing load and reduce electric power consumption. Therefore, by making the selection as described above, it is possible to reduce electric power consumption.

Note that, it is also possible for the portable device 100 to receive information indicating desired accuracy from the communication unit 200 and select the wireless communication standard and the location information calculation algorithm on the basis of the received information. Alternatively, the communication unit 200 may instruct the portable device 100 about the wireless communication standard and the location information calculation algorithm to be selected, and the portable device 100 may select the wireless communication standard and the location information calculation algorithm in accordance with the instruction from the communication unit 200.

(3) Flow of Process

Control Over Transmission Interval of Location Information Acquisition Signal

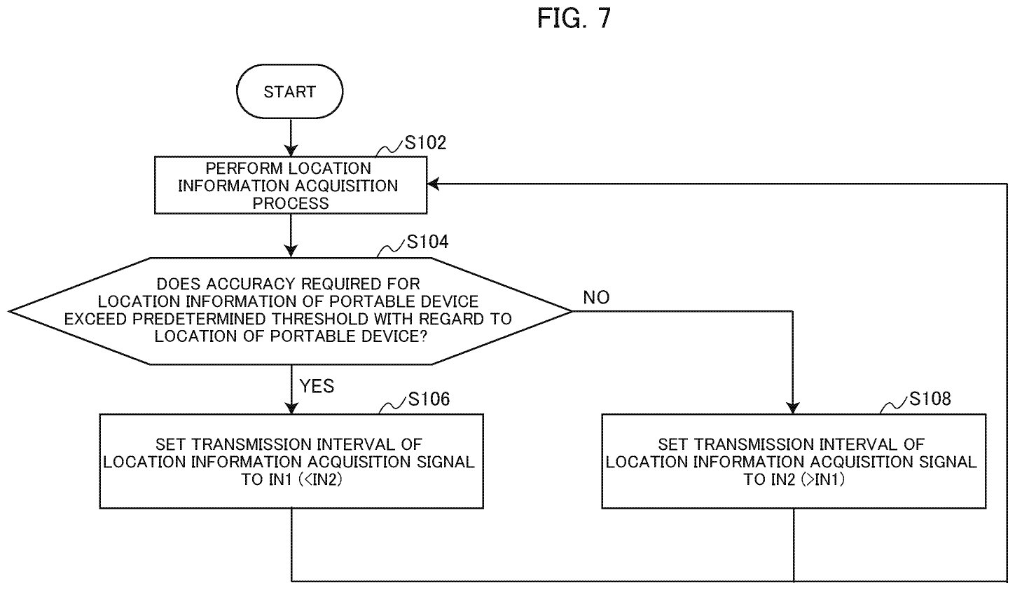

FIG. 7 is a flowchart illustrating an example of a flow of a process executed by the communication unit 200 according to the present embodiment. As illustrated in FIG. 7, the communication unit 200 first performs the location information acquisition process (Step S102). Specifically, the wireless communication section 210 performs wireless communication with the portable device 100. Next, the control section 230 acquires the location information of the portable device 100 on the basis of a result of the wireless communication performed by the wireless communication section 210. Next, the control section 230 determines whether or not accuracy required for the location information of the portable device 100 exceeds a predetermined threshold with regard to the location of the portable device 100 (Step S104). Note that, the location of the portable device 100 is indicated by the location information acquired by the communication unit 200 through the location information acquisition process in Step S102.

In the case where it is determined that the accuracy required for the location information of the portable device 100 exceeds the predetermined threshold (YES in Step S104), the control section 230 sets the transmission interval of the location information acquisition signal to an interval IN1 that is shorter than an interval IN2 (to be described later) (Step S106). In other words, the control section 230 sets a timing of executing a next location information acquisition process to a timing at which the interval IN1 elapses. Next, the process proceeds to Step S102 again, and the location information acquisition process is executed after the interval IN1 elapses.

In the case where it is determined that the accuracy required for the location information of the portable device 100 is lower than the predetermined threshold (NO in Step S104), the control section 230 sets the transmission interval of the location information acquisition signal to the interval IN2 that is longer than the above-described interval IN1 (Step S108). In other words, the control section 230 sets a timing of executing a next location information acquisition process to a timing at which the interval IN2 elapses. Next, the process proceeds to Step S102 again, and the location information acquisition process is executed after the interval IN2 elapses.

Control Over Reception Standby Interval of Location Information Acquisition Signal

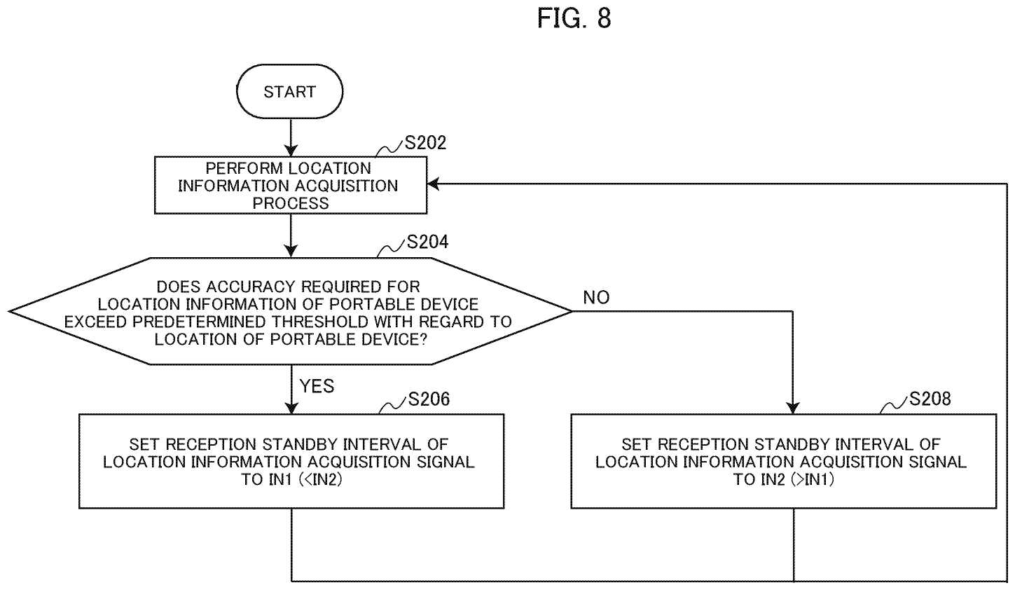

FIG. 8 is a flowchart illustrating an example of a flow of a process executed by the portable device 100 according to the present embodiment. As illustrated in FIG. 8, the portable device 100 first performs the location information acquisition process (Step S202). Specifically, the wireless communication section 110 performs wireless communication with the communication unit 200. Next, the control section 130 determines whether or not accuracy required for the location information of the portable device 100 exceeds a predetermined threshold with regard to the location of the portable device 100 (Step S204). Note that, the location of the portable device 100 is indicated by the location information acquired by the communication unit 200 through the location information acquisition process in Step S202. It is also possible for the control section 130 to receive the location information that is acquired by the communication unit 200 through the location information acquisition process in Step S202, and to make a determination as described above on the basis of the received location information.

In the case where it is determined that the accuracy required for the location information of the portable device 100 exceeds the predetermined threshold (YES in Step S204), the control section 130 sets the reception standby interval of the location information acquisition signal to the interval IN1 that is shorter than the interval IN2 (Step S206). In other words, the control section 130 sets a timing of executing a next location information acquisition process to a timing at which the interval IN1 elapses. Next, the process proceeds to Step S202 again, and the location information acquisition process is executed after the interval IN1 elapses.

In the case where it is determined that the accuracy required for the location information of the portable device 100 is lower than the predetermined threshold (NO in Step S204), the control section 130 sets the reception standby interval of the location information acquisition signal to the interval IN2 that is longer than the interval IN1 (Step S208). In other words, the control section 130 sets a timing of executing a next location information acquisition process to a timing at which the interval IN2 elapses. Next, the process proceeds to Step S202 again, and the location information acquisition process is executed after the interval IN2 elapses.

Control Over Wireless Communication Standard and Location Information Calculation Algorithm

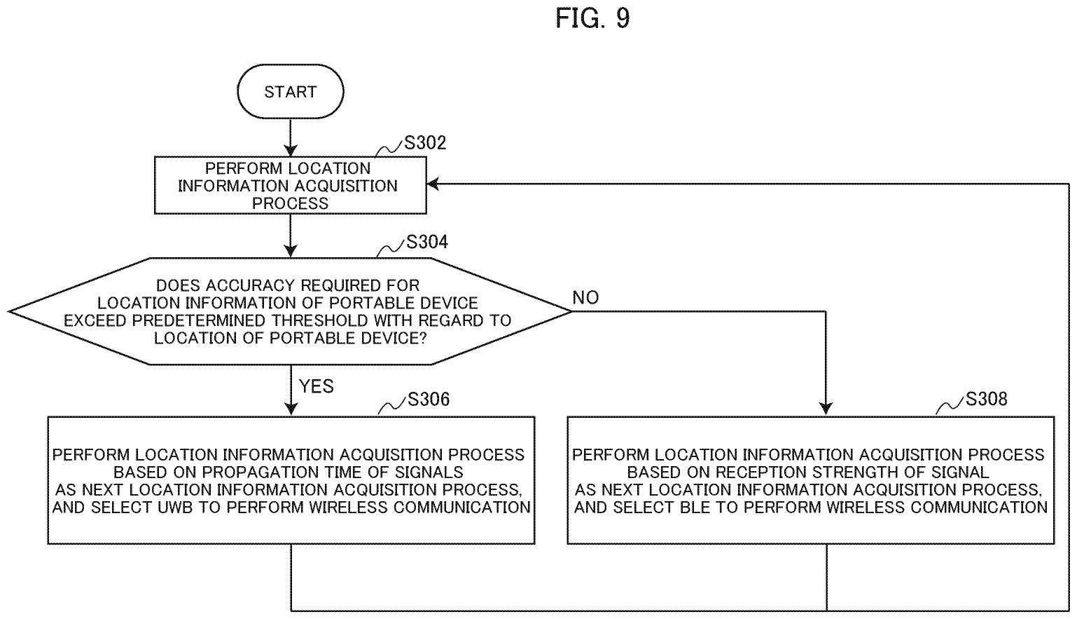

FIG. 9 is a flowchart illustrating an example of a flow of a process executed by the communication unit 200 according to the present embodiment. As illustrated in FIG. 9, the communication unit 200 first performs the location information acquisition process (Step S302). Specifically, the wireless communication section 210 performs wireless communication with the portable device 100. Next, the control section 230 acquires the location information of the portable device 100 on the basis of a result of the wireless communication performed by the wireless communication section 210. Next, the control section 230 determines whether or not accuracy required for the location information of the portable device 100 exceeds a predetermined threshold with regard to the location of the portable device 100 (Step S304). Note that, the location of the portable device 100 is indicated by the location information acquired by the communication unit 200 through the location information acquisition process in Step S302.

In the case where it is determined that the accuracy required for the location information of the portable device 100 exceeds the predetermined threshold (YES in Step S304), the control section 230 performs the location information acquisition process based on propagation time of signals as a next location information acquisition process, and selects UWB to perform the wireless communication (Step S306). Next, the process proceeds to Step S302 again, the wireless communication is performed by using the UWB in the next location information acquisition process, and location information of the portable device 100 is acquired on the basis of the propagation time of signals.

In the case where it is determined that the accuracy required for the location information of the portable device 100 is lower than the predetermined threshold (NO in Step S304), the control section 230 performs the location information acquisition process based on reception strength of a signal as a next location information acquisition process, and selects BLE to perform wireless communication (Step S308). Next, the process proceeds to Step S302 again, the wireless communication is performed by using BLE in the next location information acquisition process, and location information of the portable device 100 is acquired on the basis of the reception strength of the signal.

<3. Supplement>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, according to the above-described embodiment, the location information of the portable device 100 is information indicating the distance between the communication unit 200 and the portable device 100. However, the present invention is not limited thereto. For example, the location information of the portable device 100 may be information indicating an angle of a location where the portable device 100 is present with respect to the communication unit 200. For example, the angle of the location where the portable device 100 is present with respect to the communication unit 200 is an angle between a coordinate axis and a line connecting an origin and the location where the portable device 100 is present in a coordinate system in which the origin corresponds to the location of the wireless communication section 210. Note that, the communication unit 200 may be provided with a plurality of antennas, and the angle may be estimated from a phase difference between signals that are transmitted from the portable device 100 and received by the respective antennas. For another example, the location information of the portable device 100 may be information indicating coordinates of the portable device 100 relative to the communication unit 200. For example, the coordinates of the portable device 100 may be estimated from a result of ranging and a result of estimating the angle.

For example, according to the above-described embodiment, the first ranging signal described in the example illustrated in FIG. 2 and the ranging start instruction signal described in the example illustrated in FIG. 3 are exemplified as the location information acquisition signals whose transmission intervals are to be controlled. However, the present invention is not limited thereto. For example, a transmission interval of a signal to be transmitted from the portable device 100 may be controlled in the case of a location information acquisition process that is triggered when the portable device 100 transmits the signal. Examples of such a signal include the ranging signal described in the example illustrated in FIG. 4. In this case, the communication unit 200 controls a transmission interval of a signal to be transmitted from the portable device 100 by transmitting information to the portable device 100, the information indicating the transmission interval of the signal to be transmitted from the portable device 100.

For example, according to the above-described embodiment, the communication unit 200 acquires the location information of the portable device 100. However, the present invention is not limited thereto. The roles of the portable device 100 and the communication unit 200 may be reversed. For example, it is also possible for the portable device 100 to acquire location information indicating a location where the communication unit 200 is present. In addition, the roles of the portable device 100 and the communication unit may be switched dynamically. In addition, the location information acquisition process may be performed between the communication units 200.

For example, according to the above-described embodiment, the present invention is applied to the smart entry system. However, the present invention is not limited thereto. The present invention is applicable to any system that acquires location information through transmission/reception of a signal. For example, the present invention is applicable to a pair of any two devices selected from a group including portable devices, vehicles, smartphones, drones, houses, home appliances, and the like. In this case, one in the pair acquires location information of the other in the pair. Note that, the pair may include two device of a same type, or may include two devices of different types.

For example, according to the above-described embodiment, the standard using UWB and the standard using BLE have been exemplified as the wireless communication standards. However, the present invention is not limited thereto. For example, it is also possible to use a standard using infrared as the wireless communication standard.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts are not necessarily executed in the order illustrated in the drawings. Some processing steps may be executed in parallel. In addition, additional processing steps may be employed and some processing steps may be omitted.

### REFERENCE SIGNS LIST

1 system
100 portable device
110 wireless communication section
120 storage section
130 control section
200 communication unit
202 vehicle
210 wireless communication section
220 storage section
230 control section

1. A communication device comprising:
a wireless communication section configured to perform wireless communication with another communication device; and
a control section configured to control a location information acquisition process of acquiring location information indicating a location where the other communication device is present, on a basis of accuracy required for the location information,
wherein the control section executes, as the location information acquisition process, a process including acquisition of the location information based on a result of wireless communication between the wireless communication section and the other communication device.

2. The communication device according to claim 1, wherein
the accuracy required for the location information is set for each location, and
the control section controls the location information acquisition process on a basis of accuracy required for location information set for a location where the other communication device had been present, the location being indicated by the location information acquired in past.

3. The communication device according to claim 1, wherein
the location information is used for providing a service corresponding to the location where the other communication device is present, and
the accuracy required for the location information is set for each service.

4. The communication device according to claim 3, wherein
the communication device is installed in a vehicle,
the other communication device is a device that is carried and used by a user of the vehicle, and
the service is related to remote operation of the vehicle.

5. The communication device according to claim 1,
wherein the accuracy required for the location information is set on a basis of amount of battery charge remaining in at least any of the communication device and the other communication device.

6. The communication device according to claim 1, wherein
the wireless communication performed in the location information acquisition process includes repetitive transmission of a signal for acquiring the location information, and
the control section controls a transmission interval set for the repetitive transmission of the signal for acquiring the location information.

7. The communication device according to claim 6,
wherein the control section lengthens the transmission interval as the accuracy required for the location information deteriorates.

8. The communication device according to claim 1, wherein
the wireless communication performed in the location information acquisition process uses any of a plurality of wireless communication standards, and
the control section selects any of the plurality of wireless communication standards to be used in the location information acquisition process.

9. The communication device according to claim 1, wherein
as the acquisition of the location information based on a result of wireless communication performed by the wireless communication section in the location information acquisition process, the control section selects acquisition of location information based on propagation time of the signal or acquisition of location information based on reception strength of the signal.

10. A communication device comprising:
a wireless communication section configured to perform wireless communication with another communication device; and
a control section configured to control a location information acquisition process on a basis of a signal received from the other communication device, the location information acquisition process being a process where the other communication device acquires location information on a basis of accuracy required for the location information indicating a location where the communication device is present,
wherein, as the location information acquisition process, the control section controls a process including wireless communication between the wireless communication section and the other communication device.

11. The communication device according to claim 10, wherein
the wireless communication performed in the location information acquisition process includes a process of repeatedly receiving a signal for causing the other communication device to acquire the location information, and
the control section controls a reception standby interval set for the repetitive reception of the signal for causing the other communication device to acquire the location information.

12. A control method comprising:
performing wireless communication with another communication device; and
controlling a location information acquisition process of acquiring location information indicating a location where the other communication device is present, on a basis of accuracy required for the location information,
wherein the control over the location information acquisition process includes execution of a process including acquisition of the location information based on a result of wireless communication with the other communication device, as the location information acquisition process.

13. (canceled)
